(19) United States
(12) Patent Application Publication
(10) Pub. No.: US 2026/0308787 A1
(43) Pub. Date: Oct. 8, 2026

(54) PLANE PARALLEL CONVERGING GAS FLOW ELECTROLYZER, CELL AND USE THEREOF

(71) Applicant: Elyser B.V., Amsterdam (NL)

(72) Inventor: Rudi Pieters, Amsterdam (NL)

(21) Appl. No.: 19/679,030

(22) Filed: May 15, 2026

Related U.S. Application Data
(63) Continuation of application No. PCT/NL2024/050627, filed on Nov. 21, 2024.

(30) Foreign Application Priority Data
Nov. 22, 2023 (NL) 2036327

(51) Int. Cl. C25B 13/02; C25B 1/04; C25B 9/60; C25B 9/73; C25B 11/02

(52) U.S. Cl. CPC C25B 13/02; C25B 1/04; C25B 9/60; C25B 9/73; C25B 11/02

(57) ABSTRACT

An electrolyzer for generating hydrogen from water including electrodes and an electrically non-conductive separator layer extending in a substantially vertical plane including macroscopic through holes. The electrodes themselves include an anode and a cathode. The electrodes are each disposed at opposite faces of the separator. The electrodes each comprise a plurality fins. Each fin of the plurality of fins projects outwardly from the layer for restricting the upward movement of electrode generated bubbles to a bubble stream that is substantially parallel to the vertical plane.

### CROSS-REFERENCE TO RELATED APPLICATIONS

This application is a continuation application of International Application No. PCT/NL2024/050627, titled “PLANE PARALLEL CONVERGING GAS FLOW ELECTROLYZER, CELL AND USE THEREOF”, filed Nov. 21, 2024, which claims priority to and the benefit of Netherlands Patent Application No. 2036327, titled “PLANE PARALLEL CONVERGING GAS FLOW ELECTROLYZER, CELL AND USE THEREOF”, filed Nov. 22, 2023, and the specifications and claims thereof are incorporated herein by reference.

### BACKGROUND OF THE INVENTION

### Field of the Invention

Embodiments of the present invention relate to an electrolyzer for generating hydrogen from water, and more precisely, an electrolyzer comprising electrodes and an electrically non-conductive separator layer extending in a substantially vertical plane wherein the electrodes themselves comprise an anode and a cathode.

### Background

Renewable energy sources such as solar and wind power have an increasingly important role in energy generation. A significant problem related to renewable sources is that these sources are often stranded (in remote locations) and not dispatchable (availability is not synchronized with demand). The time scale of the dispatch mismatch ranges from minutes to hours as a consequence of the diurnal cycle in the case of solar energy, to several months due to seasonal variance of production and consumption.

A way to address this is to convert the collected energy into chemical energy for transport and storage. Photovoltaics and wind turbines both generate electricity. With electrolysis this electricity can be used to split water into hydrogen and oxygen. The hydrogen can be transported via pipeline and stored for later use or can be converted into other substances (such as ammonia) for transport and storage.

An impediment for wide-spread use of this approach is the high cost of electrolyzer equipment, which is currently in the order of € 1,000 per kW of installed capacity. Important drivers for the high cost are the use of (semi)precious metals as catalyst and the requirement to separate the product gases after they evolve on the electrodes of the electrolytic cells.

For the gas separation, three approaches are described in literature:
1. Use of a semi-permeable membrane
   In this approach, a membrane of a suitable material (e.g. Nafion®) is placed between the electrodes to keep the gas bubbles that evolve on the electrodes separated. A disadvantage of this approach is the high cost and limited lifetime of the membranes. It also adds to the complexity of cell construction.
2. Force the electrolyte through porous electrodes
   In this approach, a pumping system is used to force the electrolyte through the electrodes which have been made porous. The flow carries the gas bubbles through the electrode on which they evolved and away from the opposite electrode. Disadvantages of this approach are the added cost of the pumping system, added complexity and the energy required to maintain an adequate flow rate.
3. Use of hydrodynamic forces
   In this approach, the gas bubbles are kept separate separated by confining them to an area close to the electrode on which they evolved. Disadvantages of this approach are the need to maintain adequate velocity of the electrolyte flow, adding cost and complexity to the system. It also requires a minimum separation between the electrodes, which reduces the efficiency of the cell.

At current cost levels, adding electrolysis to renewable energy system to make the collected energy transportable and storable would at least double the cost of the entire system. A more economical method for electrolysis would enable renewable energy to cover a larger part of the energy mix.

Patent no. US 2010213052 A1, by Roy E. McAlister hereinafter, US'052 in particular teaches an alternative in which an electrolyzer makes use of buoyancy forces to separate the generated gases. In US'052, the buoyant forces are employed to direct the flow of the gas bubbles ‘distal’ to the opposing electrode. However, notably, paragraph [0056] of US'052 gives much reason to believe that this solution requires constructing separators from numerous components, which appears challenging to do in a cost-effective way.

Another issue with the embodiment of US'052 depicted in FIG. 4 thereof is mixing of the product gases, wherein some of the bubbles formed near the inner edges of the electrode components will rise through the central opening and are likely to coalesce, causing flow disturbances.

This application refers to various publications as a matter of giving a more complete background. Such reference shall not be interpreted as an admission that such publications are prior art for purposes of determining patentability of the present invention.

### BRIEF SUMMARY OF THE INVENTION

One of the objectives of the present invention is to provide a cost effective alternative electrolyzer to semi-permeable membranes, porous electrodes and confining bubbles while maintaining an adequate electrolyte flow.

Preferably the electrodes are each furnished at opposite faces of the separator layer, such as a plate, and that the electrodes each comprise a plurality of fins and wherein each fin of the plurality of fins projects outwardly from the separator layer for restricting the upward movement of electrode generated bubbles to a bubble stream that is substantially parallel to the vertical plane. The invention more preferably pertains to electrolyzers in which no space for electrolysis is provided between the electrodes and the separator.

The fins may extend substantially perpendicular to a main plane of the separator plate as viewed in lateral cross section. The main plane here typically corresponds to the vertical plane when in use.

The person skilled in the art will understand that the fins may alternatively protrude outwards in a downwards direction also, or curved downwards—such as ever so slightly downwards—along their leading edge. In either the perpendicular and downward angled configuration, with respect to the main plane of the separator plate, generated bubbles will be restricted in their upward movement and will follow the fins along the vertical plane.

The electrolyzer can typically be used in a cell comprising a housing, an electrolyte water solution within the housing, wherein the electrolyzer is arranged within said housing such that the anode and cathode are at least partially submerged in said water solution.

The simplicity of the cell design presents an opportunity to increase the operating temperature of the electrolyzer stack while maintaining stack lifetime. A higher operating temperature increase the effectivity of the catalyst which makes it practical to replace precious metals with semi-precious metals while still achieving limited cell overpotential at reasonable current densities.

The electrodes may comprise an electrode plate and the plurality of fins protruding therefrom. These electrode plates would extend in planes that are substantially parallel to the plane of the separator layer. In the case of parallel planar electrodes as described in this disclosure, this implies that the flow direction is parallel to the plane of the electrodes. In this disclosure, in contrast to US'052, the bodies of electrolyte in contact with the opposing electrodes would beneficially be separated by an impermeable boundary with macroscopic through holes, such as 1 mm-200 mm in width, and optionally forming slits the length of a proximal fin. The macroscopic through holes may themselves comprise a permeable membrane, optionally of the same material as the separator layer, but porous. In such a case the permeable membrane can be integral with the layer. Alternatively, the through holes can be provided with a membrane material that is different from the separator layer. In either case the remainder of the separator layer is designed to be non-permeable to electrolytes. The through holes may be interrupted or uninterrupted along the length of a slit. The dimensions of the through holes can be taken separate from any other feature in this portion of the description and are combinable with all embodiments of the invention. Beneficially buoyancy forces are by grace of the design according to the invention used to direct the flow of the gas bubbles to a path parallel to the plane of the electrodes which takes the bubbles around these openings as they rise. The approach of this disclosure allows for a cell design which is more compact and much easier to fabricate.

The anode and cathode electrodes are preferably, as it were, placed back-to-back with an electrical insulation in between. Here the separator layer is a plate providing such insulation. The ions, that is to say electrolytes, in use, may in one example travel between the electrodes through holes which are distributed across the electrode plates. To prevent gas bubbles travelling through these through holes and mixing, a barrier may be replaced directly beneath each opening to deflect the rising gas bubbles around the opening. The fins may be arranged so as to form said barrier. As such, more in general, the separator plate may be provided with through holes between vertically spaced fins of the plurality of fins, wherein said fins are provided as a barrier to prevent rising gases from being exchanged through the separator plate.

To reduce stagnant bubbles which could otherwise form at the electrodes and in doing so improve contact between the electrode and the water, the plurality of fins of each electrode may form pairs of upwardly converging fins. These fins of each pair of fins converge without meeting for, in use, merging and releasing the bubble streams of the fins as one upward stream. In use, is also separately from this option is a term that refers to a state wherein the electrolyzer is provided with an electrical current while at least partially submerged in water for actively separating water into hydrogen H₂ and oxygen O₂. By presenting the bubbles with a converging flow path a gaseous displacement of water is kept very close to the separator plate. The buoyancy effect of the rising bubbles draws in a preferential flow along the fins through the separator while gaseous exchange from one side of the separator plate to another side remains low. This allows for rapid electrolyte regeneration which in turn improves the efficacy of the electrolyzer.

In one example the through holes are macroscopic, that is to say about 1 mm to about 200 mm in width, optionally designed as slits with a substantially equal upward angle compared to the converging fins. This arrangement adds to the electrical resistance of the cell, but with these suitable dimensions this additional resistance is less than the typical resistance of semi-permeable membrane and the efficiency penalty is believed to be comparable to the penalty of pumped electrolyte solutions. In some embodiments, the electrodes are partially integrated into the separator plate. In other examples the electrodes are fixed to an outer surface of the separator plate.

Optionally, the electrodes comprise a metal plate, wherein the fins are provided on such plate and project outwardly from the separator plate by projecting outwardly from said metal plate. The barriers, which may be the fins, should be positioned in such a way that, in use, the bubble stream is deflected to areas or channels where the bubbles can subsequently rise to the top of the electrode plates unimpeded. This arrangement reduces the local density of bubbles along the fins, wherein density should not be confused with mass density, but is simply given to mean the local volume ratio of gas over liquid. Also, the turbulence in the vicinity of the openings nearer to the top of the electrode plates is reduced. This reduces the mixing of the product gases due to cross-over of bubbles between the sides of the back-to-back electrodes.

In one example any surface of the electrodes, such as the fins, which is directly below an opening or facing the opposite electrode is covered with a suitable material to prevent evolution of gas bubbles in these areas. As an example, polytetrafluorethylene (PTFE) can be used to cover these areas for its qualities as an electrical insulator and its resistance to corrosion. However, the person skilled in the art will understand that other materials may also be used.

The electrolyzer, as mentioned, may find an increased production performance in cell designs wherein the plate partitions the inner volume between the anode and cathode respectively and wherein the inner walls of the housing of each partition of the cell comprise electrical conductors optionally covered with catalyst which are electrically conductively connected to the anode and cathode respectively, for improving the efficacy of the cell. In more general terms an upper surface of the plurality of fins of each electrode may be electrically isolated, such as by a non-conductive coating.

In one embodiment the fins of adjacent pairs are integrally formed as a V-shaped ridge.

This prevents bubbles form coalescing to form a separate diffuse column of rising bubbles which may cause disturbances in the larger fluid flow in a cell.

In yet another embodiment multiple pairs of fins are vertically spaced apart from each other so that, in use, an upward bubble stream of one pair adds to an upward bubble stream of another pair of the multiple pairs, and wherein the space between pair forming fins defines a vertical bubble path parallel to the vertical plane. This further improves efficacy.

In one embodiment, an alternative to the V-shaped ridge is proposed, where the fins of each electrode are at least substantially angled upward for, in use, merging and releasing the bubble streams of the fins as one upward stream. A V-shaped ridge might negatively affect the separation of gases when the cell scale is scaled up, and a plurality of openings in the cell, such as more than 5, overlaps. Gas separation is an important aspect of hydrogen electrolysis generally, as the mixing of hydrogen and oxygen can cause a significant reaction in the form of an explosion, negatively impacting performance of the cell and even causing death, which is of course not desirable.

It is also possible to protrude the fins slightly relative to their complementary through hole by, such as with an overhang, in order to even further prevent explosion hazards and making it easier to scale up the cell—in particular in the vertical direction. In this context, a fin overhang refers to the portion of the fin extending beyond the main structure. Or in other words, the part of the fin that extends beyond the through hole. A fin overhang provides an advantage in managing bubbles by directing fluid flow around the fin, thereby reducing vortices. Vortex formation adversely affects efficiency and safety by causing turbulent mixing of hydrogen and oxygen gases, leading to potential explosive hazards. Additionally, vortices impede the release of gas bubbles from electrode surfaces, reducing effective reaction areas and causing uneven current distribution.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a diagram showing a cross-section of an arrangement of the back-to-back anode and cathode with openings and barriers according to an embodiment of the present invention;

FIG. 2 is a schematic illustration showing an arrangement of openings, barriers, and channels where the bubbles are collected, and the direction of bubble flow resulting from this arrangement, according to an embodiment of the present invention;

FIG. 3 is a schematic illustration showing an arrangement of the overall collector plate, including barriers to conduct the product gases to opposite sides of the electrolyzer stack, according to an embodiment of the present invention;

FIG. 4 is a diagram showing an arrangement of a part of the stack of collector plates, including the gas separation barrier, according to an embodiment of the present invention;

FIG. 5 is a diagram showing the cross-section of an electrolyzer cell with example sizes according to an embodiment of the present invention;

FIG. 6 is a diagram showing an arrangement of openings, barriers, and channels where the bubbles are collected, and the direction of bubble flow resulting from this arrangement, wherein the arrangement shows the fins angled upward, according to an embodiment of the present invention; and

FIG. 7 is a diagram showing an arrangement of openings, barriers, and channels according to an embodiment of the present invention.

### DETAILED DESCRIPTION OF THE INVENTION

Whenever in the figures the same reference numerals are applied, these numerals refer to the same parts.

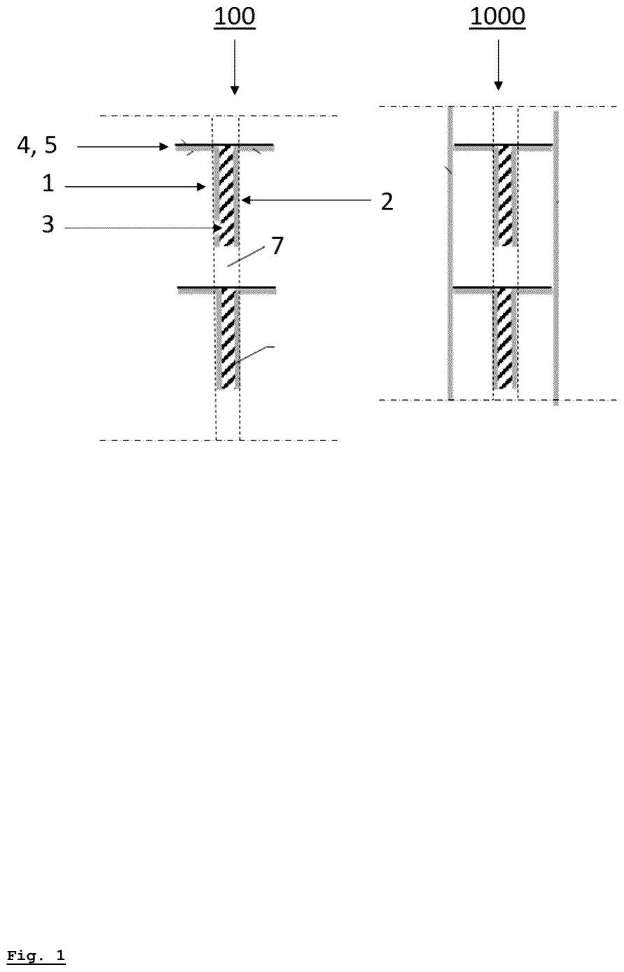

In FIG. 1 electrolyzer 100 is shown in cross-section. The electrolyzer serves for generating hydrogen from water comprising electrodes and an electrically non-conductive separator plate 3 extending in a substantially vertical plane comprising macroscopic through holes 7. In this example these through holes are about 2 mm in width, but these dimensions are not set in stone and the person skilled in the art know that these may vary depending on the size of the cell that one intends to assemble. The electrodes themselves comprise anode 1 and cathode 2, characterized in that electrodes 1, 2 are each furnished at opposite faces of separator 3. Electrodes 1, 2 each have a plurality fins 4, 5 and wherein each fin of the plurality of fins projects outwardly from plate 3 for restricting the upward movement of electrode generated bubbles to a bubble stream that is substantially parallel to the vertical plane. The electrolyzer is also shown as applied in electrolyzer cell 1000. Also, separately from this example the plurality of fins are designed to extend to inner wall of a housing of a cell. The fins thus form barriers by a protruding from a plate of the electrode itself. Electrode 1, 2 can be formed by a lanced metal sheet. Through holes 7 are shown to be provided to separator plate 3 between vertically spaced of fins 4, 5. The upper surface of each fin is, in this example at least, covered with an electrically insulating coating to prevent bubbles from forming on them. A suitable material for this coating is Polytetrafluoroethylene (PTFE) or Perfluoroalkoxy alkane (PFA) as those materials combine excellent corrosion resistance with good electrical insulation. The coating can be applied using the powder coating technique with parts of the electrodes masked while applying the powder. This arrangement deflects the flow of bubbles away from the openings towards the top of the electrode plate. This reduces the amount of cross-over of bubbles to the other side of the anode-cathode assembly and hence improves the separation of the product gases.

The space between the electrode plates is occupied by separator plate 3 which is an electrical insulator completely covering the areas of the plates facing each other. The electrode plates are themselves interrupted in places where through holes extend between separator plate 3. The exposed parts of separator plate 3 are covered with a coating to protect it from corrosion. If PTFE or PFA is used for the insulation of ridge x1, then enamel is a suitable material for the insulation of separator plate 3 as it can withstand the temperature needed to bake the PTFE/PFA coating and can easily be applied to metals. Also, separately from the above and compatible with all embodiments a plate of each electrode comprises ridge x1 which protrudes outwardly from the plate for, in use, directing rising bubbles from the plurality of fins 4, 5 of said electrode to an outlet. The ridge may further be at least partially curved along the plane of said electrode.

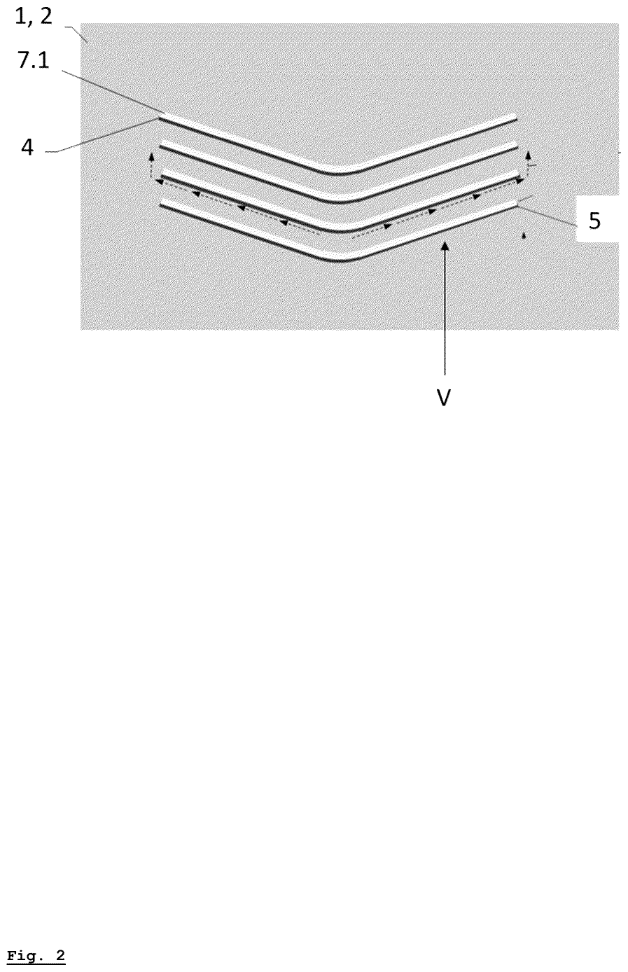

FIG. 2 shows one side of one of electrodes 1, 2 of electrolyzer 100. Here it is shown that “the electrode comprises a plate which itself also comprises through holes 7.1 which correspond to through holes 7 of the separator plate”. It is noted that the quoted portion may be introduced into the claimed separately as a feature as it is compatible with all embodiments of the invention. In a more detailed example fins 4, 5 are lanced from the electrode plate. Each fin is integral with an adjacent fin forming the shape of a shallow V with a rounded angle. The upward angle of both fins 4, 5 deflects the flow of the bubbles to the side and around the openings between other fins of the plurality also forming a V towards the top of the plate. The rounded angle is intended to limit the stretch of the material when lancing the barrier. Shallow here means an angle between 100-170 degrees between integral fins.

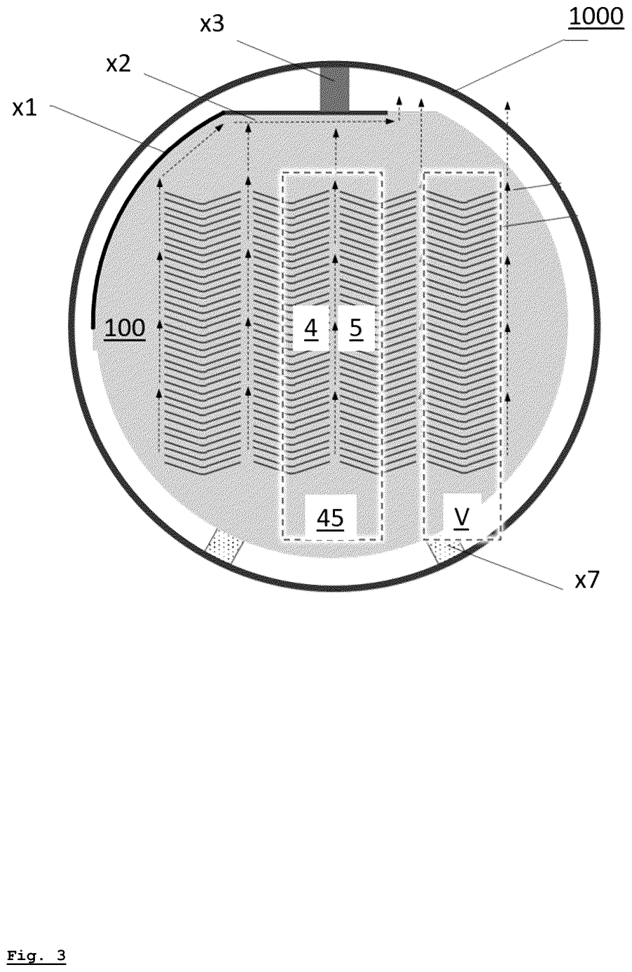

Referring to FIG. 3, in some embodiments a plurality fins 4, 5 forming pairs 45 and V-shaped fins, as depicted in detail in FIG. 2. The space between V-shaped fins define channels in which generate bubbles rise upwards. Ridge x1, formed by bending a part of the electrode plate deflects the rising bubble flow sidewards x2 so all gas evolving on the electrode plate is expelled at one side of the plate. In the assembled stack, these ridges are pressed against the flat plates separating the cells. The opposing electrode has a similar ridge which deflects the bubble flow to the opposing side of the electrode plate. This arrangement allows for the product gases to be collected separately on the opposing sides of the cell stack. The product gases can be further kept separate by a barrier x3 between the top of the cell stack and the containing vessel. Supports x7 keep the cell stack isolated from the containing vessel.

Through the lanced protrusions, also referred to as fins 4, 5 and ridges x1 described previously, each separator plate is in electrical contact with the adjacent anode and cathode. The electrical insulation between the anode and cathode provides the electrical insulation between successive cells, which obviates the need for separate gaskets, further simplifying the fabrication of the stack. The cell stack can be fabricated by alternating stacking of a combined anode/cathode plate and a separator plate between two end plates which are connected with tensions rods or springs.

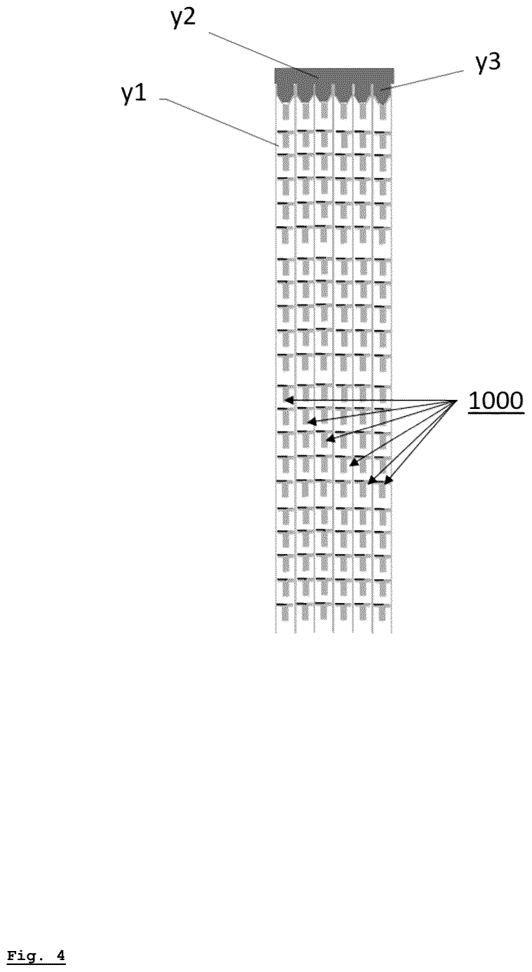

Referring to FIG. 4, lateral stack y1 of collector and separator plates is seen in cross-section. Gas separation barrier y2 is placed at the top of the stack. The barrier is formed of a single piece of a material with sufficient elasticity to secure a gas-tight fit with the top of the stacked plates. Protrusions y3 of the barrier fit in the gaps formed by ridges which deflect the gas bubbles sideways as indicated in FIG. 3, label x1.

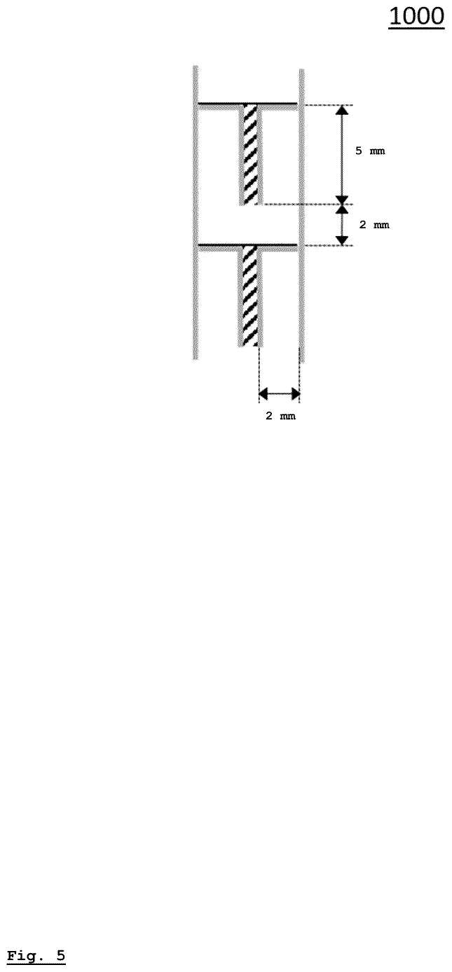

Referring to FIG. 5, with the dimensions shown therein the contribution to the cell overpotential by the resistivity of the electrolyte (35%-weight KOH at 50° C. and a current density of 0.5 A/cm2) is about 0.6 V, which is the same magnitude as for a standard cell with a gap of 4 mm between the electrodes and a semi-permeable membrane. For approached based on forced electrolyte flow, the overpotential of a standard cell with a gap of 4 mm is in the order of 0.4 V. When the operating temperature is increased to 150° C. (which would be impractical when a membrane is used) the contribution of the electrolyte resistivity is reduced to 0.3 V. So, the overpotential penalty of the arrangement in the current disclosure is at most limited and can be avoided altogether by choosing a higher operating temperature.

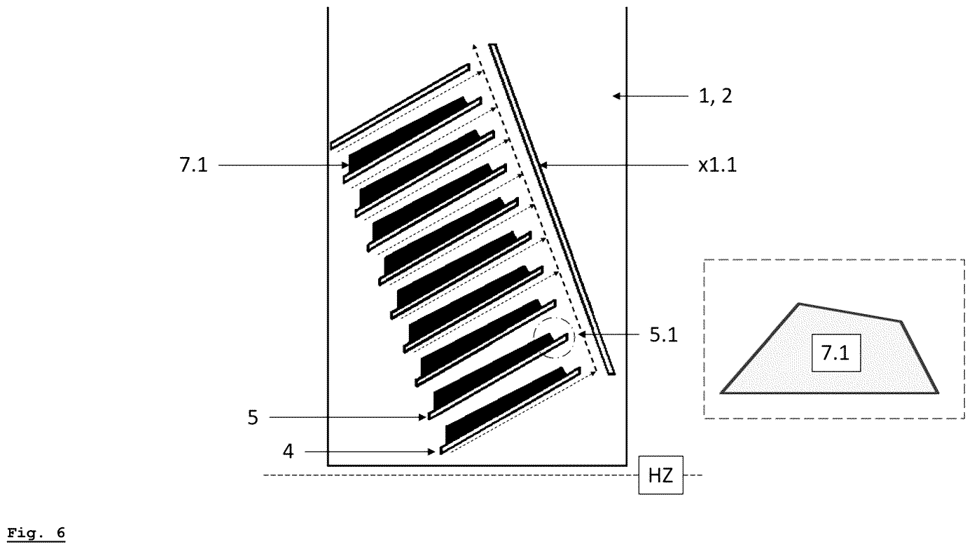

Referring to FIG. 6, a plurality of fins 4, 5 of each electrode is shown, which are at least substantially angled upward for, in use, merging and releasing the bubble streams of the fins as one upward stream. This is advantageous due to the fact that gas separation is promoted, and a larger cell can be constructed with a more significant overlap of through holes 7. The fins preferably each comprise overhang 5.1, which protrudes at least partially beyond through holes 7, such as at least 1 mm, as to beneficially prevent a vortex or vortices in the upward bubble stream, ultimately preventing gas mixing.

FIG. 6 particularly shows that the following features which, also be separately from this particular example, can be applied to the invention. The plurality of fins 4, 5 of each electrode can be at least substantially angled upward with respect to horizontal ‘HZ’. In this particular example it was found that 25-45 degrees promotes a steady bubble flow, when in use. Guide fin x1.1 may furthermore be provided for, in use, guiding and merging the bubble streams of the fins as one upward stream. This upward moving bubble steam is preferably guided at an angle with respect to vertical so as to prevent vortices from disrupting the steady fluid flow along the electrodes. To this end guide fin x1.1 may be designed so as to be-in particular its guide surface-substantially perpendicular, read 80-100 degrees with respect, to the direction in which the fins extend along the separator plate 3. Preferably, the distance between the end of consecutive fins of the plurality of fins 4, 5 and the guide fin x1.1 increases or stays the same in an upward direction. This beneficially accommodates an increasingly larger gaseous flow as streams merge. To this end fin x1.1 is preferably about 90 to about 95 degrees with respect to the direction in which the fins extend along the separator plate.

Entirely separate from this particular figurative example, but shown in FIG. 6, is the design of through holes 7. From a view facing separator plate 3 each through hole 7 is designed as a slit that extends through separator plate 3 along a fin of the plurality of fins 4, 5 and which slit narrows in the direction that the fin rises. Beneficially this allows a bubble stream to become greater as a fin rises without allowing bubbles to cross over, while also allowing an effective exchange between components dissolved in the liquid.

One particular design is found to be most favorable for a linear cumulative increase in bubble flow size. To this end the slit may be designed as an irregular quadrilateral in which none of the angles of the quadrilateral are equal to each other and which the height of the quadrilateral narrows in the direction that the fin rises. An exaggerated view of the quadrilateral is shown on the right hand side of FIG. 6.

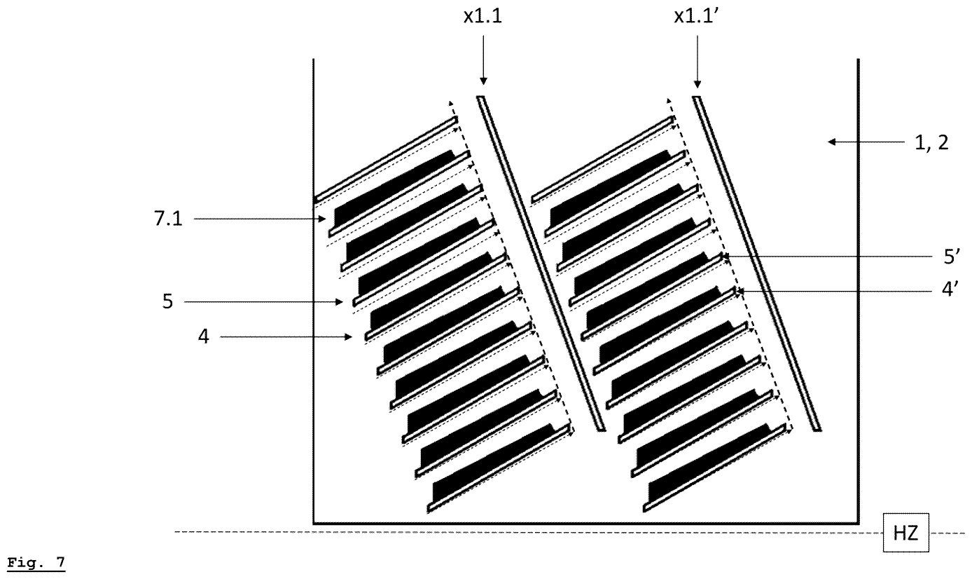

FIG. 7 shows that the guide fin also allows for closer horizontal spacing of the vertical arrays of fins and openings, making more efficient use of the available surface area within the cells. The term array here refers to the slanted columnar structure as formed by the fins. The slanted columnar structure is also visible in FIG. 6.

FIG. 7 shows that each electrode may comprise a further plurality of fins 4′, 5′ also forming an array, such as the slanted columnar structure. This arrangement is beneficial for gaseous production. However, this form requires arrays to be spaced apart for quite a bit. In this particular embodiment however, a part of one array of fins extends vertically above the array. This is not usually the case, as bubbles would in other circumstances cross over between arrays. This would impede production and disturb fluid flows. In FIG. 7 however guide fin x1.1 extends between these arrays such that the bubbles are prevented from crossing over between structures. To this end the length of the guide fin is preferably 80-120% of the length of an array, which is measured as the distance between the lower fin and the upper fin in the same array. It stands to reason that the further plurality if fins 4′, 5′ may be provided with its own guide fin x1.1′, so as to repeat the design of FIG. 6.

Note that in the specification and claims, “about” or “approximately” means within twenty percent (20%) of the numerical amount cited.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

What is claimed is:

1. An electrolyzer for generating hydrogen from water comprising:
electrodes and an electrically non-conductive separator layer extending in a substantially vertical plane comprising macroscopic through holes, wherein the electrodes themselves comprise an anode and a cathode;
wherein the electrodes are each disposed at opposite faces of the separator, wherein the electrodes each comprise a plurality fins and wherein each fin of the plurality of fins projects outwardly from the separator layer for, in use, restricting the upward movement of electrode generated bubbles to a bubble stream that is substantially parallel to the vertical plane.

2. The electrolyzer according to claim 1, wherein the electrodes each comprise a single plate which extends in a plane parallel to the plane the vertical plane of the separator layer.

3. The electrolyzer according to claim 2, wherein the plate of each electrode comprises a ridge which protrudes outwardly from the plate for, in use, directing rising bubbles from the plurality of fins of the electrode to an outlet.

4. The electrolyzer according to claim 1, wherein the plurality of fins of each electrode is at least substantially angled upward between about 10 to about 45 degrees from horizontal, and wherein a guide fin is provided for, in use, guiding and merging the bubble streams of the fins as one upward stream, wherein the guide fin makes about an 80 to about a 100 degree angle with respect to the direction in which the plurality of fins extend.

5. The electrolyzer according to claim 4, wherein the plurality of fins form a slanted columnar structure.

6. The electrolyzer according to claim 5, wherein each electrode further comprises a plurality of fins also forming a slanted columnar structure, and wherein a part of one slanted columnar structure of the two structures extends vertically above the other columnar structure, and wherein the guide fin extends between these structures such that, in use, bubbles are prevented from crossing over between structures.

7. The electrolyzer according to claim 1, wherein the macroscopic through holes are each designed as a slit that extends through the separator plate along a fin of the plurality of fins and which slit narrows in the direction that the fin rises, and wherein the through holes are preferably designed as an irregular quadrilateral in which none of the angles of the quadrilateral are equal to each other.

8. The electrolyzer according to claim 1, wherein the plurality of fins of each electrode form pairs of upwardly converging fins, and wherein the fins of each pair of fins converge without meeting for, in use, merging and releasing the bubble streams of the fins as one upward stream.

9. The electrolyzer according to claim 8, wherein the fins of adjacent pairs are integrally formed as a V-shaped ridge forming a shallow angle between pairs between about 100 and about 170 degrees.

10. The electrolyzer according to claim 8, wherein multiple pairs of fins are vertically spaced apart from each other so that, in use, an upward bubble stream of one pair adds to an upward bubble stream of another pair of the multiple pairs, and wherein the space between pair forming fins defines a vertical bubble path parallel to the vertical plane.

11. The electrolyzer according to claim 1, wherein an upper surface of the plurality of fins of each electrode is electrically isolated.

12. The electrolyzer according to claim 11, wherein the through holes are provided between vertically spaced fins of the plurality of fins, directly above and along each fin of the plurality of fins, wherein the fins are provided as a barrier to prevent rising gases from being exchanged through the separator layer.

13. The electrolyzer according to claim 1, wherein the fins each comprise an overhang which protrudes at least partially beyond the through holes.

14. An electrolyzer cell comprising:
a housing defining an internal volume;
an electrolyte water solution within the housing; and
the electrolyzer according to claims 1 arranged within the housing.

15. The cell according to claim 14, wherein lateral sides of the housing are fluid impermeable and wherein the lateral walls facing the inner volume are provided with electrical conductors associated with the electrodes to increase the total active surface area of the electrodes of the electrolyzer.

16. A stack arrangement of electrolyzer cells comprising laterally and vertically adjacent cells, wherein the cells are cells according to claim 14.

17. The use of an electrolyzer cell according to claim 14.

18. The electrolyzer according to claim 1, wherein the through holes comprise a width between about 1 mm and about 200 mm.

19. The electrolyzer according to claim 2, wherein the single plate of each electrode is integral with the plurality of fins of the electrode.

20. The electrolyzer according to claim 13, wherein the overhang protrudes at least about 1 mm beyond the through holes.
